(19) United States
(12) Patent Application Publication
(10) Pub. No.: US 2016/0358042 A1
(43) Pub. Date: Dec. 8, 2016

(54) Electronic Travel Album Generating Method and Computing Device

(71) Applicant: Tencent Technology (Shenzhen) Company Limited, Shenzhen (CN)

(72) Inventors: Qiang Fu, Shenzhen (CN); Hao Wu, Shenzhen (CN); Xiaochuan Xu, Shenzhen (CN); Youkun Huang, Shenzhen (CN); Xinxing Li, Shenzhen (CN); Xin Liu, Shenzhen (CN); Jing Cui, Shenzhen (CN); Linwei Chen, Shenzhen (CN); Jingjing Liu, Shenzhen (CN)

(21) Appl. No.: 15/238,442

(22) Filed: Aug. 16, 2016

Related U.S. Application Data
(63) Continuation of application No. PCT/CN2015/072893, filed on Feb. 12, 2015.

(30) Foreign Application Priority Data
Feb. 24, 2014 (CN) 201410063332.4

(51) Int. Cl. G06K 9/62; G06T 11/60; G06K 9/00

(52) U.S. Cl. CPC G06K 9/6267; G06K 9/00664; G06T 11/60

(57) ABSTRACT

An electronic travel album generating method includes the following steps: acquiring imported photos; acquiring shooting time and shooting address information of the photos; sequencing the photos according to the shooting time; categorizing the sequenced photos into categories according to an arrangement sequence; acquiring scenic spot information corresponding to each category according to the shooting address information of photos of each category; and encoding the photos into an electronic travel album according to the shooting time of the photos, a sequencing result obtained by the sequencing step, category information obtained by the categorizing step, and the scenic spot information corresponding to each category. With the electronic travel album generating method, an electronic travel album can be simply and quickly generated. In addition, a computing device for generating an electronic travel album is further provided.

### PRIORITY CLAIM AND RELATED APPLICATIONS

This application is a continuation of International Application No. PCT/CN2015/072893, entitled “Electronic Travel Album Generating Method and System” filed on Feb. 12, 2015, which claims priority to Chinese Patent Application No. 201410063332.4, entitled “Electronic Travel Album Generating Method and System” filed on Feb. 24, 2014, both of which are incorporated by reference in their entirety.

### TECHNICAL FIELD

The present disclosure relates to the field of computer technologies, and in particular, to an electronic travel album generating method and computing device.

### BACKGROUND

An electronic album may be understood as electronic data that is formed by organizing a plurality of pictures in a certain arrangement form by using a categorization method and can be browsed by using a web browser, a picture reader, a video player, or the like. The pictures in the album may include photos that are shot, pictures that are made, and the like.

Making an exquisite electronic album from photos or pictures of interest is a thing that many users desire to do. For example, after experiencing a memorable travel and shooting a lot of travel photos, a user desires to make an electronic travel album from the travel photos, so as to permanently save the electronic travel album, upload the electronic travel album to a network social platform (such as microblog) to share it with friends, or the like.

However, generally, making an electronic travel album is almost a heavy work and needs to be completed by using some electronic album tool softwares, and therefore, a user needs to be familiar with the electronic album tool softwares in advance. Moreover, the operation process of some electronic album tool softwares in generating an electronic travel album is complicated, thereby failing to simply and quickly generate an electronic travel album.

### SUMMARY

On the basis of the above, it is necessary to provide an electronic travel album generating method that can simply and quickly generate an electronic travel album.

An electronic travel album generating method includes the following steps:
acquiring imported photos;
acquiring shooting time and shooting address information of the photos;
sequencing the photos according to the shooting time;
categorizing the sequenced photos into categories according to an arrangement sequence;
acquiring scenic spot information corresponding to each category according to the shooting address information of photos of each category; and
encoding the photos into an electronic travel album according to the shooting time of the photos, a sequencing result obtained by the sequencing step, category information obtained by the categorizing step, and the scenic spot information corresponding to each category.

In addition, it is further necessary to provide a computing device for generating an electronic travel album that can simply and quickly generate an electronic travel album.

A computing device for generating an electronic travel album includes: one or more processors; a memory; and one or more program modules stored in the memory and executed by the one or more processors, the one or more program modules comprising:
a photo acquiring module, configured to acquire imported photos;
a shooting information acquiring module, configured to acquire shooting time and shooting address information of the photos;
a sequencing module, configured to sequence the photos according to the shooting time;
a categorizing module, configured to categorize the sequenced photos into categories according to an arrangement sequence;
a scenic spot information acquiring module, configured to acquire scenic spot information corresponding to each category according to the shooting address information of photos of each category; and
an album generating module, configured to encode the photos into an electronic travel album according to the shooting time of the photos, a sequencing result obtained by the sequencing step, category information obtained by the categorizing step, and the scenic spot information corresponding to each category.

With the electronic travel album generating method and computing device, shooting time and shooting address information of imported photos can be automatically acquired, the photos are sequenced according to shooting time, the sequenced photos are categorized into categories according to an arrangement sequence, scenic spot information corresponding to each category is automatically acquired according to shooting address information of photos of each category, and the photos is further encoded into an electronic travel album according to the shooting time of the photos, a sequencing result obtained by the sequencing step, category information obtained by the categorizing step, and the scenic spot information corresponding to each category, thereby simply and quickly generating the electronic travel album.

### BRIEF DESCRIPTION OF THE DRAWINGS

FIG. 1 is a schematic flowchart of an electronic travel album generating method in one embodiment;

FIG. 2 shows a displayed electronic travel album that is generated by using an electronic travel album generating method in one embodiment;

FIG. 3 is a schematic structural diagram of an computing device for generating an electronic travel album in one embodiment;

FIG. 4 is a schematic structural diagram of an computing device for generating an electronic travel album in another embodiment; and

FIG. 5 is a block diagram of a computing device 1000 that can implement embodiments of the present invention.

### DETAILED DESCRIPTION OF EMBODIMENTS

In order to make objectives, technical solutions, and advantages of the present disclosure clearer, the present disclosure is further described in detail below with reference to the accompanying drawings and embodiments. It should be understood that specific embodiments described herein are only used to explain the present disclosure, but not to limit the present disclosure.

Unless the context clearly indicates otherwise, singular elements or components in the present disclosure may be in the plural and vice versa, which is not limited in the present disclosure. Although steps in the present disclosure are labeled with numbers, such numbers are not intended to limit the order of these steps. Unless the order of steps is explicitly stated or it is explicitly stated that a step needs to be performed on the basis of another step, the relative order of steps can be adjusted. It should be understood that as used herein, the term “and/or” involves and includes any and all combinations of one or more of the associated listed items.

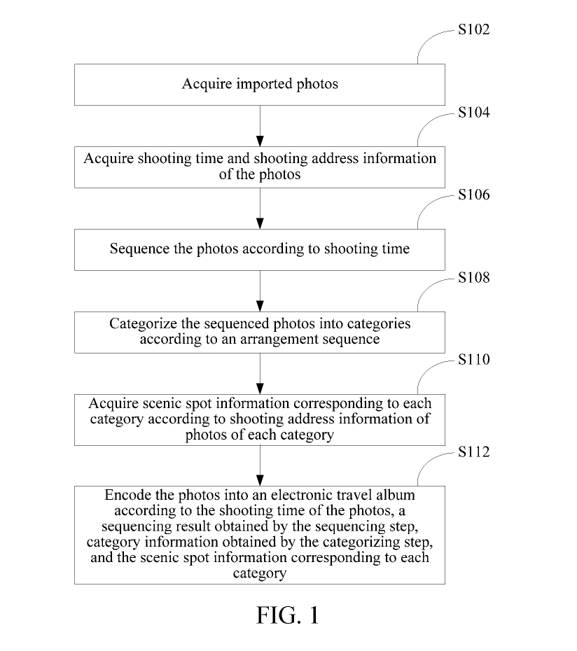

As shown in FIG. 1, an electronic travel album generating method includes the following steps:

Step S102: Acquire imported photos.

In one embodiment, a photo uploading interface may be provided, uploaded photos are received by using the photo uploading interface, and in step S102, the uploaded photos may be acquired. In another embodiment, an instruction for making an album from photos stored in a server may be acquired, photos specified by the instruction are imported, and further, in step S102, the imported photos specified by the instruction may be acquired.

Step S104: Acquire shooting time and shooting address information of the photos.

In one embodiment, shooting time and the latitude and longitude of a shooting address in exchangeable image file (EXIF) information of a photo may be extracted. EXIF is an image file format, of which data storage is exactly the same as that of a JPEG format. An EXIF format refers to that information about a digital photo, including an aperture, a shutter, date and time, the latitude and longitude of a shooting address, and the like when the digital photo is shot, is inserted at a header of a JPEG format.

In one embodiment, if the EXIF information of the photo is not extracted or the shooting time or the latitude and longitude of the shooting address in the EXIF information is not extracted, an interface for inputting shooting time and shooting address information of a photo may be provided, and input shooting time and shooting address information of a photo is received by using the interface. The input shooting address information may be scenic spot information, such as a name of a scenic spot.

Step S106: Sequence the photos according to shooting time.

In one embodiment, the photos may be arranged in an ascending sequence according to shooting time.

Step S108: Categorize the sequenced photos into categories according to an arrangement sequence.

In categorizing the photos into categories according to an arrangement sequence, it is required that photos categorized to a same category are continuous photo sequences in sequenced photo sequences. It may be understood that a photo sequence may only include one photo.

In one embodiment, step S108 includes a step of categorizing the sequenced photos into categories according to a shooting time interval: categorizing continuous photo sequences, in the sequenced photos, of which a shooting time interval between adjacent photos is less than or equal to a first threshold, to a same category.

The first photo in photo sequences may be categorized to a first category, and further, all photos after the first photo in the photo sequences are sequentially traversed, where a currently traversed photo is categorized to a category according to the following step: categorizing, if a shooting time interval between the currently traversed photo and a previous photo is less than or equal to the first threshold, the currently traversed photo to a category to which the previous photo belongs; or categorizing, if a shooting time interval between the currently traversed photo and a previous photo is greater than the first threshold, the currently traversed photo to a new category.

In this embodiment, photos between which a shooting time interval is less than a certain range are automatically gathered to a same category, and the shooting time interval between the photos being small indicates that the photos may be shot at a same scenic spot. Therefore, in this embodiment, photos that are shot at a same scenic spot can be automatically categorized to a same category.

In this embodiment, the step of categorizing the sequenced photos into categories according to a shooting time interval may further include: merging two adjacent categories if a sum of the numbers of photos of the two adjacent categories is less than or equal to a preset parameter and a shooting time interval between two adjacent photos in the two adjacent categories is greater than the first threshold and is less than a third threshold. In one embodiment, the preset parameter may be specified as a number obtained by multiplying a certain proportion by the total number of the imported photos (for example, a quarter of the total number of the imported photos). In another embodiment, the preset parameter may be specified as a number obtained by multiplying a certain proportion by the total number of photos of which shooting time is within a same time period, for example, the same time period may be the date of the shooting time of the photos of the foregoing two adjacent categories, that is, the total number of photos of which shooting time is within the date the same as that of the shooting time of the photos of the foregoing two adjacent categories may be counted. If the sum of the numbers of the photos of the foregoing two adjacent categories is less than or equal to a number obtained by multiplying a certain proportion (for example, a quarter) by the total number of the photos, and a shooting time interval between two adjacent photos in the two adjacent categories is greater than the first threshold and is less than a third threshold, the two adjacent categories are merged.

A specific value of the first threshold for determining whether to categorize two adjacent photos to a same category is difficult to accurately set. Therefore, in this embodiment, a flexible range from the first threshold to the third threshold is added, where if a shooting time interval between two adjacent photos in two adjacent categories is greater than the first threshold and is less than the third threshold, and a sum of the numbers of photos of the two adjacent categories is less than or equal to a preset parameter, the two adjacent categories are merged. The photos can be more properly categorized into categories by combining a plurality of aspects, so that photos shot at a same scenic spot are categorized to a same category as far as possible.

In another embodiment, step S108 includes a step of categorizing the sequenced photo into categories according to a shooting distance: calculating a shooting distance between adjacent photos in the sequenced photos according to the shooting address information, and categorizing continuous photo sequences, in the sequenced photos, of which a shooting distance between adjacent photos is less than or equal to a second threshold, to a same category.

The first photo in photo sequences may be categorized to a first category, and further, all photos after the first photo in the photo sequences are sequentially traversed, where a currently traversed photo is categorized to a category according to the following step: categorizing, if a shooting distance between the currently traversed photo and a previous photo is less than or equal to the second threshold, the currently traversed photo to a category to which the previous photo belongs; or categorizing, if a shooting distance between the currently traversed photo and a previous photo is greater than the second threshold, the currently traversed photo to a new category.

In this embodiment, photos between which a shooting distance is less than a certain range are automatically gathered to a same category, and the shooting distance between the photos being small indicates that the photos may be shot at a same scenic spot. Therefore, in this embodiment, photos that are shot at a same scenic spot can be automatically categorized to a same category.

In this embodiment, the step of categorizing the sequenced photos into categories according to a shooting distance may further include: merging two adjacent categories if a sum of the numbers of photos of the two adjacent categories is less than or equal to a preset parameter and a shooting distance between two adjacent photos in the two adjacent categories is greater than the second threshold and is less than a fourth threshold.

In this embodiment, the photos can be more properly categorized into categories by combining a plurality of aspects, so that photos shot at a same scenic spot are categorized to a same category as far as possible.

In one embodiment, before the categorizing sequenced photos into categories according to a shooting time interval or a shooting distance, step S108 further includes the following step: categorizing photos of which shooting time is within a same specified time period to a same broad category, for example, categorizing photos of which shooting time is within a same day to a same broad category. Further, in step S108, sequenced photos of a same broad category may be categorized into categories according to a shooting time interval or a shooting distance.

Step S110: Acquire scenic spot information corresponding to each category according to shooting address information of photos of each category.

In one embodiment, step S110 includes: calculating a center point location of shooting addresses of the photos of each category according to the shooting address information of the photos of each category; and acquiring scenic spot information corresponding to the center point location.

In one embodiment, in step S104, the latitude and longitude of a shooting address of a photo are acquired. The latitude and longitude of shooting addresses of the photos of each category may be converted into Gauss plane rectangular coordinates by means of Gauss projection (that is, Gauss-Krüger projection). The Gauss plane rectangular coordinates of all the photos of each category are weighted and averaged to obtain Gauss rectangular coordinates of a center point of shooting addresses of the photos of each category. Further, the Gauss rectangular coordinates of the center point is converted into latitude and longitude by means of Gauss projection, so as to obtain the latitude and longitude of the center point of the shooting addresses of the photos of each category.

Further, a point of interest (POI) server may be searched for corresponding scenic spot information according to the latitude and longitude of the center point corresponding to the photos of each category. The POI server stores navigation map information, where each piece of navigation map information includes a name, a category, latitude, longitude, and the like. A name corresponding to the latitude and longitude and obtained by searching the POI server may be regarded as a name of a scenic spot.

In another embodiment, in step S104, the input shooting address information of the photos is received. Associating and matching may be performed between input shooting address information of the photos of each category and names included in the navigation map information stored in the POI server to obtain associated and matched names and acquire the latitude and longitude corresponding to the associated and matched names, thereby obtaining the latitude and longitude of a shooting address corresponding to each photo of the category. Further, the latitude and longitude of the center point of the shooting addresses of the photos of each category is obtained (the specific process is as described above). Further, the POI server may be searched for corresponding scenic spot information according to the latitude and longitude of the center point corresponding to the photos of each category, thereby obtaining the scenic spot information corresponding to each category.

Step S112: Encode the photos into an electronic travel album according to the shooting time of the photos, a sequencing result obtained by the sequencing step, category information obtained by the categorizing step, and the scenic spot information corresponding to each category.

In one embodiment, photos of a same category may be arranged in a same area, where an arrangement sequence of the photos of the same category and an arrangement sequence of photos of different categories are consistent with sequences of the photos in a sequencing result. In addition, the scenic spot information corresponding to each category may be arranged in the area at which the photos of each category are located. A shooting time period corresponding to each category may be further obtained according to the shooting time of the photos of each category, for example, if shooting time of a photo is kept accurate to the second, a shooting time period corresponding to each category may be kept accurate to the day. Further, the shooting time period corresponding to each category may be arranged in the area at which the photos of each category are located.

In one embodiment, photos of which shooting time is within a same specified time period are categorized into a same broad category, where the categorizing the photos into categories according to a shooting time interval or a shooting distance is performed on sequenced photos of a same broad category. In step S112, photos of a same broad category may be arranged in a same broad area; and photos of different categories in the same broad category may be arranged in small areas in the corresponding broad area. In step S112, time period information corresponding to broad categories may be encoded into a menu, where each piece of time period information corresponds to one option in the menu, and each option is provided with a function of linking to a broad area of a broad category corresponding to the corresponding time period information. In this embodiment, photos in a corresponding time period may be quickly jumped to by selecting an option, thereby improving the operation convenience.

In one embodiment, step S112 further includes: generating a travel track according to the shooting time of the photos of each category and the scenic spot information corresponding to each category.

Track points corresponding to categories may be generated, where one category corresponds to one track point; paths with directions between the track points form a travel track; the direction of each path points to a track point of which corresponding shooting time is later from a track point of which corresponding shooting time is earlier; and each track point is provided with a function of linking to an area corresponding to a corresponding category. Information bars corresponding to the track points may further be generated, where one information bar corresponds to one track point, and an information bar of a track point includes a shooting time period and scenic spot information of a category corresponding to the track point. In this embodiment, corresponding photos may be quickly jumped to by selecting a track point, thereby improving the operation convenience.

In one embodiment, step S112 further includes: generating a map travel track, in combination with a world map, according to the shooting time of the photos of each category and the scenic spot information corresponding to each category. The generated travel track may be embedded into the world map to generate the map travel track, where track points are located at positions of scenic spots in the world map that correspond to the track points.

In one embodiment, step S112 further includes: generating an input area for inputting and displaying experiences and thoughts about travelling a scenic spot.

The input area for inputting and displaying experiences and thoughts about travelling a scenic spot may be generated in the area corresponding to each category. A user may edit experiences and thoughts about travelling a corresponding scenic spot by using the input area.

In one embodiment, the electronic travel album generating method may further include a step of: parsing and displaying the generated electronic travel album.

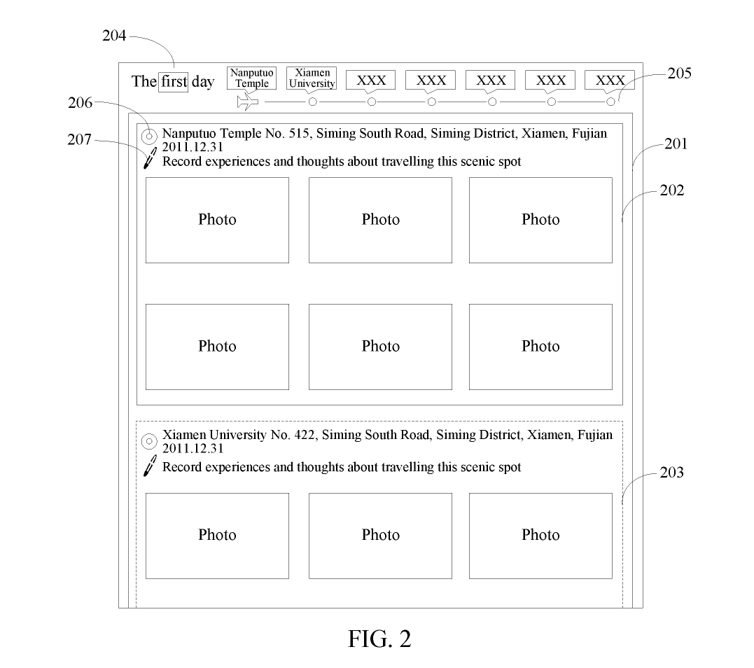

FIG. 2 shows a displayed electronic travel album that is generated by using an electronic travel album generating method in one embodiment. A process for generating the electronic travel album displayed in FIG. 2 mainly includes the following steps:

(1) Sequence the imported photos according to shooting time, categorize photos of which shooting time is within a same day in the imported photos to a same broad category, set a shooting time period of the first broad category as the first day, and sequentially set shooting time periods of broad categories after the first broad category according to an arrangement sequence, where each shooting time period is increased by one day on the basis of a previous shooting time period from the first day, for example, a shooting time period of a second broad category is set as the second day, and the like.

(2) Categorize the sequenced photos of the same broad category into categories according to a shooting time interval or a shooting distance, and acquire scenic spot information corresponding to each category according to shooting address information of photos of each category. As shown in FIG. 2, acquired scenic spot information corresponding to categories is Nanputuo Temple, Xiamen University, and the like.

(3) Arrange the photos of the same broad category in a same broad area, and arrange the photos of different categories in the same broad category in small areas in the corresponding broad area. As shown in FIG. 2, photos shot on the first day are arranged in a broad area 201 (not completely displayed), where photos of a category corresponding to Nanputuo Temple are arranged in a small area 202 in the broad area 201, and photos of a category corresponding to Xiamen University are arranged in another small area 203 in the broad area 201.

(4) Encode time period information corresponding to broad categories into a menu, where each piece of time period information corresponds to one option in the corresponding menu, and each option is provided with a function of linking to a broad area of a broad category corresponding to the corresponding time period information. As shown in FIG. 2, the time period information (the first day, the second day, the third day, and the like) corresponding to the broad categories are encoded into a menu 204, where the time period information currently displayed in the menu 204 is “the first day”, and accordingly, the area 201 including photos shot on the first day are displayed on an interface.

(5) Generate a travel track according to shooting time of the photos of each category and the scenic spot information corresponding to each category. As shown in FIG. 2, a travel track 205 formed by track points corresponding to seven pieces of scenic spot information such as Nanputuo Temple and Xiamen University and paths between the track points is generated, where the direction of each path points to a track point of which corresponding shooting time is later from a track point of which corresponding shooting time is earlier, and in FIG. 2, the direction of each path is marked by using a flight direction of an aircraft icon. Each track point in the travel track 205 is provided with a function of linking to an area corresponding to a corresponding category. As shown in FIG. 2, a track point corresponding to Nanputuo Temple is in a selected state, and therefore, an area including photos corresponding to Nanputuo Temple is displayed on the interface.

(6) Arrange the scenic spot information and a shooting date corresponding to each category in an area at which the photos of each category are located. As shown in FIG. 2, the area 202 corresponding to Nanputuo Temple includes an information bar 206 for displaying scenic spot information and a shooting date, where the information bar 206 includes scenic spot information: a name of the scenic spot: “Nanputuo Temple”, an address of the scenic spot: “No. 515, Siming South Road, Siming District, Xiamen, Fujian”, and a shooting date: “2011.12.31”.

(7) Generate an input area for inputting and displaying experiences and thoughts about travelling a scenic spot in the area corresponding to each category, for example, an input area 207 in FIG. 2. As shown in FIG. 2, before a user inputs experiences and thought about travelling, the input area 207 displays “Record experiences and thoughts about travelling this scenic spot”, and after the user inputs the experiences and thought about travelling, the input area displays information input by the user.

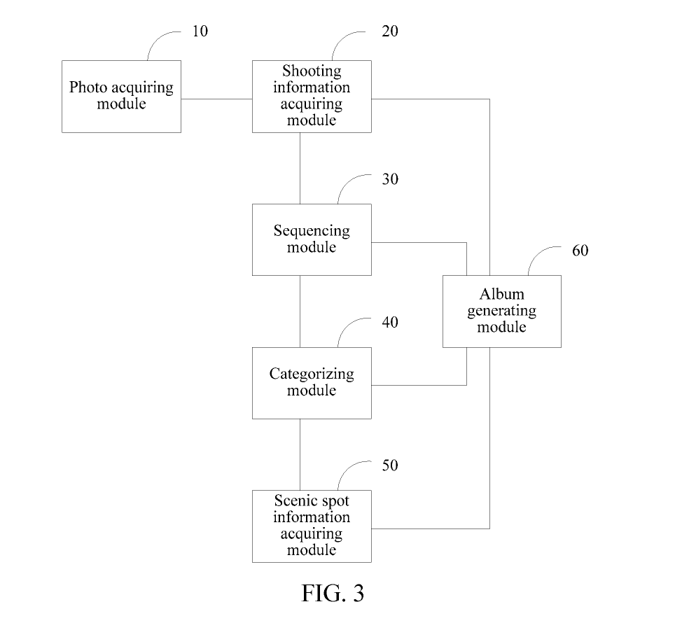

As shown in FIG. 3, a computing device for generating an electronic travel album includes one or more processors; a memory; and one or more program modules stored in the memory and executed by the one or more processors, the one or more program modules including: a photo acquiring module 10, a shooting information acquiring module 20, a sequencing module 30, a categorizing module 40, a scenic spot information acquiring module 50, and an album generating module 60.

The photo acquiring module 10 is configured to acquire imported photos.

In one embodiment, the computing device for generating an electronic travel album further includes an uploading module (not shown in the figure), configured to provide a photo uploading interface and receive the uploaded photos by using the photo uploading interface; and the photo acquiring module 10 is configured to acquire the uploaded photos. In another embodiment, the computing device for generating an electronic travel album further includes an importing module (not shown in the figure), configured to acquire an instruction for making an album from photos stored in a server and import photos specified by the instruction; and the photo acquiring module is configured to acquire the imported photos specified by the instruction.

The shooting information acquiring module 20 is configured to acquire shooting time and shooting address information of the photos.

In one embodiment, the shooting information acquiring module 20 may extract shooting time, and the latitude and longitude of a shooting address in EXIF information of a photo. EXIF is an image file format, of which data storage is exactly the same as that of a JPEG format. An EXIF format refers to that information about a digital photo, including an aperture, a shutter, date and time, the latitude and longitude of a shooting address, and the like when the digital photo is shot, is inserted at a header of a JPEG format.

In one embodiment, if the EXIF information of the photo is not extracted or the shooting time or the latitude and longitude of the shooting address in the EXIF information is not extracted, the shooting information acquiring module 20 may provide an interface for inputting shooting time and shooting address information of a photo, and receive input shooting time and shooting address information of a photo by using the interface. The input shooting address information may be scenic spot information, such as a name of a scenic spot.

The sequencing module 30 is configured to sequence the photos according to shooting time.

In one embodiment, the sequencing module 30 may arrange the photos in an ascending order according to the shooting time.

The categorizing module 40 is configured to categorize the sequenced photos into categories according to an arrangement sequence.

In categorizing the photos into categories according to an arrangement sequence, it is required that photos categorized to a same category are continuous photo sequences in sequenced photo sequences. It may be understood that a photo sequence may only include one photo.

In one embodiment, the categorizing module 40 categorizes the sequenced photos into categories according to a shooting time interval, that is, categorizes continuous photo sequences, in the sequenced photos, of which a shooting time interval between adjacent photos is less than or equal to a first threshold, to a same category.

The categorizing module 40 may categorize the first photo in photo sequences to a first category, and further, all photos after the first photo in the photo sequences are sequentially traversed, where a currently traversed photo is categorized to a category according to the following process: if a shooting time interval between the currently traversed photo and a previous photo is less than or equal to the first threshold, the currently traversed photo is categorized to a category to which the previous photo belongs; and if a shooting time interval between the currently traversed photo and a previous photo is greater than the first threshold, the currently traversed photo is categorized to a new category.

In this embodiment, photos between which a shooting time interval is less than a certain range are automatically gathered to a same category, and the shooting time interval between the photos being small indicates that the photos may be shot at a same scenic spot. Therefore, in this embodiment, photos that are shot at a same scenic spot can be automatically categorized to a same category.

In one embodiment, the categorizing module 40 is further configured to merge two adjacent categories if a sum of the numbers of photos of the two adjacent categories is less than or equal to a preset parameter and a shooting time interval between two adjacent photos in the two adjacent categories is greater than the first threshold and is less than a third threshold. In one embodiment, the computing device for generating an electronic travel album further includes a parameter setting module (not shown in the figure), configured to specify the preset parameter as a number obtained by multiplying a certain proportion by the total number of the imported photos (for example, a quarter of the total number of the imported photos). In another embodiment, the parameter setting module may specify the preset parameter as a number obtained by multiplying a certain proportion by the total number of photos of which shooting time is within a same time period, for example, the same time period may be the date of the shooting time of the photos of the foregoing two adjacent categories. The categorizing module 40 may count the total number of photos of which shooting time is within the date the same as that of the shooting time of the photos of the foregoing two adjacent categories, and merge the two adjacent categories if the sum of the numbers of the photos of the two adjacent categories is less than or equal to a number obtained by multiplying a certain proportion (for example, a quarter) by the total number of the photos and a shooting time interval between two adjacent photos in the two adjacent categories is greater than the first threshold and is less than a third threshold.

A specific value of the first threshold for determining whether to categorize two adjacent photos to a same category is difficult to accurately set. Therefore, in this embodiment, a flexible range from the first threshold to the third threshold is added, where if a shooting time interval between two adjacent photos in two adjacent categories is greater than the first threshold and is less than the third threshold, and a sum of the numbers of photos of the two adjacent categories is less than or equal to a preset parameter, the two adjacent categories are merged. The photos can be more properly categorized into categories by combining a plurality of aspects, so that photos shot at a same scenic spot are categorized to a same category as far as possible.

In another embodiment, the categorizing module 40 is configured to categorize the sequenced photo into categories according to a shooting distance, that is, calculate a shooting distance between adjacent photos in the sequenced photos according to the shooting address information, and categorize continuous photo sequences, in the sequenced photos, of which a shooting distance between adjacent photos is less than or equal to a second threshold, to a same category.

The categorizing module 40 may categorize the first photo in photo sequences to a first category, and further, sequentially traverse all photos after the first photo in the photo sequences, and categorize a currently traversed photo to a category according to the following process: if a shooting distance between the currently traversed photo and a previous photo is less than or equal to the second threshold, the currently traversed photo is categorized to a category to which the previous photo belongs; and if a shooting distance between the currently traversed photo and a previous photo is greater than the second threshold, the currently traversed photo is categorized to a new category.

In this embodiment, photos between which a shooting distance is less than a certain range are automatically gathered to a same category, and the shooting distance between the photos being small indicates that the photos may be shot at a same scenic spot. Therefore, in this embodiment, photos that are shot at a same scenic spot can be automatically categorized to a same category.

In one embodiment, the categorizing module 40 is further configured to merge two adjacent categories if a sum of the numbers of photos of the two adjacent categories is less than or equal to a preset parameter and a shooting distance between two adjacent photos in the two adjacent categories is greater than the second threshold and is less than a fourth threshold.

In this embodiment, the photos can be more properly categorized into categories by combining a plurality of aspects, so that photos shot at a same scenic spot are categorized to a same category as far as possible.

In one embodiment, before categorizing the sequenced photos into categories according to a shooting time interval or a shooting distance, the categorizing module 40 is further configured to categorize photos of which shooting time is within a same specified time period to a same broad category, for example, categorize photos of which shooting time is within a same day to a same broad category. Further, the categorizing module 40 may categorize sequenced photos of a same broad category into categories according to a shooting time interval or a shooting distance.

The scenic spot information acquiring module 50 is configured to acquire scenic spot information corresponding to each category according to shooting address information of photos of each category.

In one embodiment, the scenic spot information acquiring module 50 is configured to calculate a center point location of shooting addresses of the photos of each category according to the shooting address information of the photos of each category, and acquire scenic spot information corresponding to the center point location.

In one embodiment, the shooting information acquiring module 20 acquires the latitude and longitude of a shooting address of a photo. The scenic spot information acquiring module 50 may convert the latitude and longitude of shooting addresses of the photos of each category into Gauss plane rectangular coordinates by means of Gauss projection (that is, Gauss-Krüger projection), weight and average the Gauss plane rectangular coordinates of all the photos of each category to obtain Gauss rectangular coordinates of a center point of shooting addresses of the photos of each category, and further convert the Gauss rectangular coordinates of the center point into latitude and longitude by means of Gauss projection, so as to obtain the latitude and longitude of the center point of the shooting addresses of the photos of each category.

Further, the scenic spot information acquiring module 50 may search a POI server for corresponding scenic spot information according to the latitude and longitude of the center point corresponding to the photos of each category. The POI server stores navigation map information, where each piece of navigation map information includes a name, a category, latitude, longitude, and the like. A name corresponding to the latitude and longitude and obtained by searching the POI server may be regarded as a name of a scenic spot.

In another embodiment, the shooting information acquiring module 20 receives input shooting address information of photos. The scenic spot information acquiring module 50 may associate and match input shooting address information of the photos of each category with names included in the navigation map information stored in the POI server to obtain associated and matched names and acquire the latitude and longitude corresponding to the associated and matched names, thereby obtaining the latitude and longitude of a shooting address corresponding to each photo of the category; may further acquire the latitude and longitude of the center point of the shooting addresses of the photos of each category (the specific process is as described above); and further search the POI server for corresponding scenic spot information according to the latitude and longitude of the center point corresponding to the photos of each category, thereby obtaining the scenic spot information corresponding to each category.

The album generating module 60 is configured to encode the photos into an electronic travel album according to the shooting time of the photos, a sequencing result obtained by the sequencing step, category information obtained by the categorizing step, and the scenic spot information corresponding to each category.

In one embodiment, the album generating module 60 may arrange photos of a same category in a same area, where an arrangement sequence of the photos of the same category and an arrangement sequence of photos of different categories are consistent with sequences of the photos in a sequencing result. In addition, the album generating module 60 may arrange the scenic spot information corresponding to each category in an area at which the photos of each category are located. The album generating module 60 may further obtain a shooting time period corresponding to each category according to shooting time of the photos of each category, for example, if shooting time of a photo is kept accurate to the second, a shooting time period corresponding to each category may be kept accurate to the day. Further, the album generating module 60 may arrange the shooting time period corresponding to each category in the area at which the photos of each category are located.

In one embodiment, photos of which shooting time is within a same specified time period are categorized to a same broad category, where the categorizing the photos into categories according to a shooting time interval or a shooting distance is performed on sequenced photos of a same broad category. The album generating module 60 may arrange photos of a same broad category in a same broad area, and arrange photos of different categories in the same broad category in small areas in the corresponding broad area. The album generating module 60 may encode time period information corresponding to broad categories into a menu, where each piece of time period information corresponds to one option in the corresponding menu, and each option is provided with a function of linking to a broad area of a broad category corresponding to the corresponding time period information. In this embodiment, photos in a corresponding time period may be quickly jumped to by selecting an option, thereby improving the operation convenience.

In one embodiment, the album generating module 60 is further configured to generate a travel track according to the shooting time of the photos of each category and the scenic spot information corresponding to each category.

The album generating module 60 may generate track points corresponding to categories, where one category corresponds to one track point; paths with directions between the track points form a travel track; the direction of each path points to a track point of which corresponding shooting time is later from a track point of which corresponding shooting time is earlier; and each track point is provided with a function of linking to an area corresponding to a corresponding category. The album generating module 60 may further generate information bars corresponding to the track points, where one information bar corresponds to one track point, and an information bar of a certain track point includes a shooting time period and scenic spot information of a category corresponding to the track point. In this embodiment, corresponding photos may be quickly jumped to by selecting a track point, thereby improving the operation convenience.

In one embodiment, the album generating module 60 is further configured to generate a map travel track, in combination with a world map, according to the shooting time of the photos of each category and the scenic spot information corresponding to each category. The album generating module 60 may embed the generated travel track into the world map to generate the map travel track, where track points are located at positions of scenic spots in the world map that correspond to the track points.

In one embodiment, the album generating module 60 is further configured to generate an input area for inputting and displaying experiences and thoughts about travelling a scenic spot.

The album generating module 60 may generate, in the area corresponding to each category, the input area for inputting and displaying experiences and thoughts about travelling a scenic spot. A user may edit experiences and thoughts about travelling a corresponding scenic spot by using the input area.

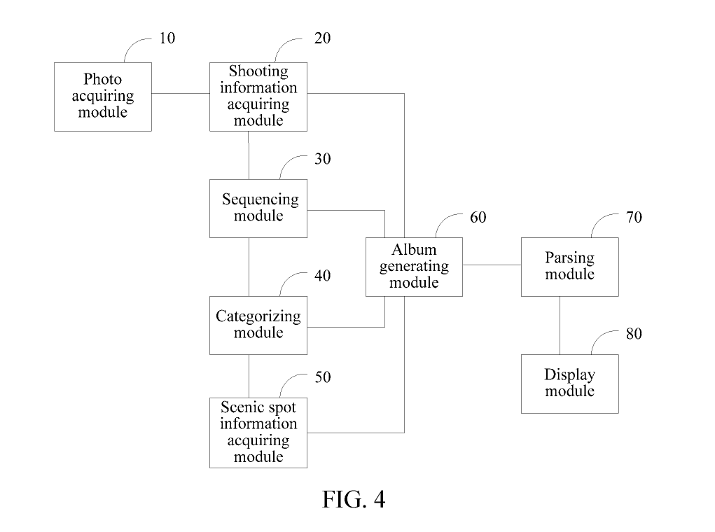

In one embodiment, as shown in FIG. 4, the computing device for generating an electronic travel album includes a parsing module 70 and a display module 80, where the parsing module 70 is configured to parse the generated electronic travel album, and the display module 80 is configured to display the parsed electronic travel album.

With the computing device for generating an electronic travel album, shooting time and shooting address information of imported photos can be automatically acquired, the photos are sequenced according to shooting time, the sequenced photos are categorized into categories according to an arrangement sequence, scenic spot information corresponding to each category is automatically acquired according to shooting address information of photos of each category, and the photos is further encoded into an electronic travel album according to the shooting time of the photos, a sequencing result obtained by the sequencing step, category information obtained by the categorizing step, and the scenic spot information corresponding to each category, thereby simply and quickly generating the electronic travel album.

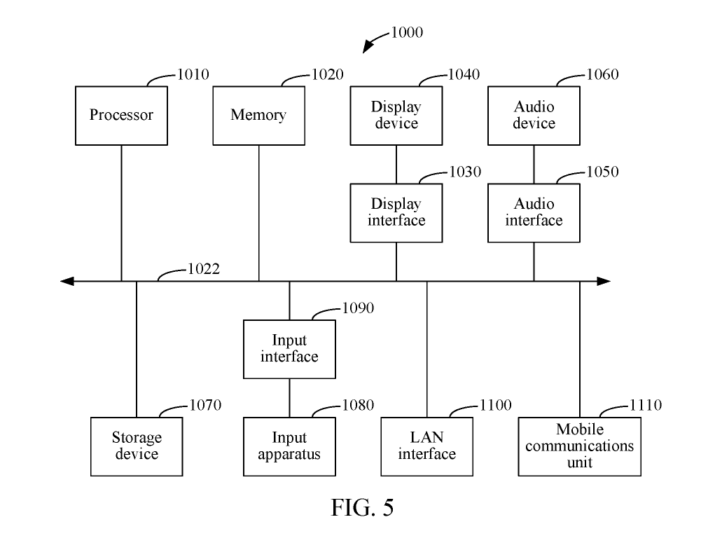

FIG. 5 is a block diagram of a computing device 1000 that can implement embodiments of the present invention. The computing device 1000 is merely an example of computing device environments applicable to the present disclosure, and should not be construed as any limitation on the application scope of the present disclosure. The computing device 1000 also should not be interpreted as needing to rely on or have one or a combination of parts of the exemplary computing device 1000.

The computing device 1000 shown in FIG. 5 is an example of computing devices suitable for use in the present disclosure. Other architectures having different subsystem configurations may also be used. For example, a desktop computer, a notebook computer, a personal digital assistant, a tablet computer, a portable media player and other similar devices well-known to the public are applicable to some embodiments of the present invention, but the present disclosure is not limited thereto.

As shown in FIG. 5, the computing device 1000 includes a processor 1010, a memory 1020 and a system bus 1022. Various system components including the memory 1020 and the processor 1010 are connected to the system bus 1022. The processor 1010 is hardware for executing computer program instructions by means of basic arithmetic and logic operations in the computing device. The memory 1020 is a physical device for temporarily or permanently storing computer programs or data (for example, program state information). The system bus 1022 may be any one of the following types of bus structures: a memory bus or memory controller, a peripheral bus and a local bus. The processor 1010 and the memory 1020 can perform data communication through the system bus 1022. The memory 1020 includes a read-only memory (ROM) or a flash memory (both not shown in the figure), and a random access memory (RAM), where the RAM generally refers to main memory loaded with an operating system and application programs.

The computing device 1000 further includes a display interface 1030 (for example, a graphics processing unit), a display device 1040 (for example, a liquid crystal display), an audio interface 1050 (for example, a sound card) and an audio device 1060 (for example, a loudspeaker). The display device 1040 and the audio device 1060 are media devices for presenting multimedia content.

The computing device 1000 generally includes one storage device 1070. The storage device 1070 may be selected from multiple categories of computer readable media. The computer readable media refer to any available media that can be accessed by the computing device 1000, and include removable media and non-removable media. For example, the computer readable media include, but not limited to, a flash memory (micro SD card), a CD-ROM, a digital versatile disc (DVD) or other optical storage, a cassette, a magnetic tape, a disk storage or other magnetic storage devices, or any other media that can be used to store required information and can be accessed by the computing device 1000.

The computing device 1000 further includes an input apparatus 1080 and an input interface 1090 (for example, an IO controller). A user may input an instruction and information into the computing device 1000 by using the input apparatus 1080, such as a keyboard, a mouse or a touch panel device on the display device 1040. The input apparatus 1080 is generally connected to the system bus 1022 through the input interface 1090, but may also be connected through other interfaces or bus structures, such as a universal serial bus (USB).

The computing device 1000 may be logically connected to one or more network devices in a network environment. The network device may be a personal computer, a server, a router, a smart phone, a tablet computer or other public network nodes. The computing device 1000 is connected to the network device through a local area network (LAN) interface 1100 or a mobile communications unit 1110. A local area network (LAN) refers to an interconnected computer network in a limited area such as a family, a school, a computer laboratory, or an office building using network media. WiFi and Ethernet over twisted pair are the most commonly used two technologies for building a local area network. WiFi is a technology that enables the computing devices 1000 to exchange data or to be connected to a wireless network through radio waves. The mobile communications unit 1110 is capable of making and receiving calls through radio communications lines while moving in a broad geographic area. In addition to calling, the mobile communications unit 1110 also supports Internet access in a 2G, 3G or 4G cellular communications system that provides mobile data services.

It should be noted that other computing devices including more or fewer subsystems than those of the computing device 1000 are also applicable to the present disclosure. For example, the computing device 1000 may include a Bluetooth unit capable of exchanging data in a short distance, an image sensor for capturing images, and an accelerometer for measuring the acceleration.

As described above in detail, the computing device 1000 applicable to the present disclosure can execute specified operations in the electronic travel album generating method. The computing device 1000 executes these operations in the form of running software instructions in the computer readable media by the processor 1010. These software instructions may be read into the memory 1020 from the storage device 1070 or from another device through the local area network interface 1100. The software instructions stored in the memory 1020 enable the processor 1010 to execute the electronic travel album generating method. Moreover, the present disclosure may also be implemented by using a hardware circuit or by using a combination of a hardware circuit and software instructions. Therefore, the implementation of the present disclosure is not limited to any particular combination of hardware circuits and software.

The foregoing embodiments only describe several implementation manners of the present disclosure, and their description is specific and detailed, but cannot therefore be understood as a limitation to the patent scope of the present disclosure. It should be noted that, a person of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. An electronic travel album generating method, comprising:
at a computing device having one or more processors and a memory storing programs executed by the one or more processors:
acquiring imported photos;
acquiring shooting time and shooting address information of the photos;
sequencing the photos according to the shooting time;
categorizing the sequenced photos into categories according to an arrangement sequence;
acquiring scenic spot information corresponding to each category according to the shooting address information of photos of each category; and
encoding the photos into an electronic travel album according to the shooting time of the photos, a sequencing result obtained by the sequencing step, category information obtained by the categorizing step, and the scenic spot information corresponding to each category.

2. The method according to claim 1, wherein categorizing the sequenced photos into categories according to an arrangement sequence, comprises:
categorizing continuous photo sequences, in the sequenced photos, of which a shooting time interval between adjacent photos is less than or equal to a first threshold, to a same category.

3. The method according to claim 1, wherein categorizing the sequenced photos into categories according to an arrangement sequence, comprises:
calculating a shooting distance between adjacent photos in the sequenced photos according to the shooting address information; and
categorizing continuous photo sequences, in the sequenced photos, of which a shooting distance between adjacent photos is less than or equal to a second threshold, to a same category.

4. The method according to claim 1, wherein acquiring scenic spot information corresponding to each category according to the shooting address information of photos of each category, comprises:
calculating a center point location of shooting addresses of the photos of each category according to the shooting address information of the photos of each category; and
acquiring scenic spot information corresponding to the center point location.

5. The method according to claim 1, wherein encoding the photos into an electronic travel album, comprises:
generating a travel track according to the shooting time of the photos of each category and the scenic spot information corresponding to each category.

6. The method according to claim 1, wherein encoding the photos into an electronic travel album, comprises:
generating an input area for inputting and displaying experiences and thoughts about travelling a scenic spot.

7. A computing device for generating an electronic travel album, comprising:
one or more processors;
a memory; and
one or more program modules stored in the memory and executed by the one or more processors, the one or more program modules comprising:
a photo acquiring module, configured to acquire imported photos;
a shooting information acquiring module, configured to acquire shooting time and shooting address information of the photos;
a sequencing module, configured to sequence the photos according to the shooting time;
a categorizing module, configured to categorize the sequenced photos into categories according to an arrangement sequence;
a scenic spot information acquiring module, configured to acquire scenic spot information corresponding to each category according to the shooting address information of photos of each category; and
an album generating module, configured to encode the photos into an electronic travel album according to the shooting time of the photos, a sequencing result obtained by the sequencing step, category information obtained by the categorizing step, and the scenic spot information corresponding to each category.

8. The computing device according to claim 7, wherein the categorizing module is configured to categorize continuous photo sequences, in the sequenced photos, of which a shooting time interval between adjacent photos is less than or equal to a first threshold, to a same category.

9. The computing device according to claim 7, wherein the categorizing module is configured to calculate a shooting distance between adjacent photos in the sequenced photos according to the shooting address information, and categorize continuous photo sequences, in the sequenced photos, of which a shooting distance between adjacent photos is less than or equal to a second threshold, to a same category.

10. The computing device according to claim 7, wherein the scenic spot information acquiring module is configured to calculate a center point location of shooting addresses of the photos of each category according to the shooting address information of the photos of each category, and acquire scenic spot information corresponding to the center point location.

11. The computing device according to claim 7, wherein the album generating module is further configured to generate a travel track according to the shooting time of the photos of each category and the scenic spot information corresponding to each category.

12. The computing device according to claim 7, wherein the album generating module is further configured to generate an input area for inputting and displaying experiences and thoughts about travelling a scenic spot.

13. A non-transitory computer readable storage medium having one or more instructions stored therein, which, when executed by a computing device, cause the computing device to:
acquiring imported photos;
acquiring shooting time and shooting address information of the photos;
sequencing the photos according to the shooting time;
categorizing the sequenced photos into categories according to an arrangement sequence;
acquiring scenic spot information corresponding to each category according to the shooting address information of photos of each category; and
encoding the photos into an electronic travel album according to the shooting time of the photos, a sequencing result obtained by the sequencing step, category information obtained by the categorizing step, and the scenic spot information corresponding to each category.
